(19) United States
(12) Patent Application Publication
(10) Pub. No.: US 2016/0163436 A1
(43) Pub. Date: Jun. 9, 2016

(54) GRAIN ORIENTED ELECTRICAL STEEL SHEET AND METHOD OF MANUFACTURING THE SAME

(71) Applicant: JFE Steel Corporation, Tokyo (JP)

(72) Inventors: Yukihiro Shingaki, Tokyo (JP); Noriko Makiishi, Tokyo (JP); Makoto Watanabe, Tokyo (JP)

(21) Appl. No.: 15/019,201

(22) Filed: Feb. 9, 2016

Related U.S. Application Data
(62) Division of application No. 13/814,054, filed on Mar. 19, 2013.

(30) Foreign Application Priority Data
Aug. 6, 2010 (JP) 2010-177764

(51) Int. Cl. H01F 1/147; C22C 38/02

(52) U.S. Cl. CPC H01F 1/14775; C22C 38/02

(57) ABSTRACT

A grain oriented electrical steel sheet includes forsterite film on a surface of base steel sheet; and an aluminum-concentrated portion in at least one of the forsterite film and an interface between the forsterite film and the base steel sheet by a presence ratio expressed as area-occupying ratio of the Al-concentrated portion, of at least 5%, per 10000 μm² of the surface of the base steel sheet, which has been subjected to magnetic domain refinement treatment by electron beam irradiation.

### RELATED APPLICATIONS

This is a divisional of U.S. Ser. No. 13/814,054, filed Feb. 4, 2013, which is a §371 of International Application No. PCT/JP2011/004440, with an international filing date of Aug. 4, 2011 (WO 2012/017669 A1, published Feb. 9, 2012), which is based on Japanese Patent Application No. 2010-177764, filed Aug. 6, 2010.

### TECHNICAL FIELD

This disclosure relates to a grain oriented electrical steel sheet having excellent iron loss properties for use in an iron core material of a transformer or the like.

### BACKGROUND

A grain oriented electrical steel sheet is mainly utilized as an iron core of a transformer and required to exhibit excellent magnetization characteristics, e.g., low iron loss in particular. In this regard, it is important to highly accord secondary recrystallized grains of a steel sheet with (110)[001] orientation, i.e., what is called “Goss orientation,” and reduce impurities in a product steel sheet. However, there are limits on controlling crystal grain orientations and reducing impurities in view of production cost. Accordingly, there have been developed techniques for iron loss reduction, which is to apply non-uniformity (strain) to a surface of a steel sheet physically to subdivide magnetic domain width, i.e., magnetic domain refinement techniques.

For example, JP-B 57-002252 proposes a technique of irradiating a steel sheet after final annealing with a laser to introduce high-dislocation density regions into a surface layer of the steel sheet, thereby narrowing magnetic domain widths and reducing iron loss of the steel sheet. Further, JP-A 62-096617 proposes a technique of controlling magnetic domain widths by irradiating a steel sheet with a plasma flame.

A manufacturing process of a grain oriented electrical steel sheet generally involves secondary recrystallization of steel facilitated by use of precipitates such as MnS, MnSe, AlN and the like referred to as “inhibitors.” A grain oriented electrical steel sheet thus manufactured by using inhibitors has a primer coating referred to as “forsterite” (coating mainly composed of Mg₂SiO₄) on a surface thereof and an insulating tension coating is often formed on this forsterite film. An insulating tension coating formed on forsterite film is useful in terms of reducing iron loss of the steel sheet, as well as causing a good effect on the base steel subjected to magnetic domain refinement described above.

JP-A 2004-353054 discloses in connection with characteristics of forsterite film that characteristics of forsterite film improve and thus a grain oriented electrical steel sheet having excellent film properties can be manufactured by using, as an annealing separator during final annealing, magnesia of which expected value in distribution of activity has been controllably set to be within a range of specific standard deviation.

We noticed, however, the following problems in connection with the production method according to JP '054. Specifically, when magnesia having the aforementioned specific activity distribution is used as annealing separator, i.e., as a material of forsterite film, a resulting formation rate of forsterite film differs from the conventionally observed rate, whereby concentration of the inhibitor elements (S, Se, Al and the like) at a surface of a steel sheet may occur concurrently with formation of forsterite film, depending on components of the steel sheet and/or annealing conditions for secondary recrystallization of steel.

JP '054 discloses that magnesia generally includes low-activity component, intermediate-activity component, and high-activity component and that good magnetic properties and satisfactory formation of a hard film of a steel sheet can be achieved in a compatible manner by adjusting the chemical composition, including these three types of components, of magnesia such that magnesia collectively meets adequate activity distribution μ(A) and adequate standard deviation σ (A), respectively. JP '054 also discloses that decomposition of inhibitors is suppressed when the annealing separator contains alkali earth metal ions such as Ca, Sr, Br or the like.

There is a known phenomenon that an inhibitor component, after decomposition of inhibitor substance in steel, tends to be concentrated at a surface of a steel sheet. Timing of forsterite film formation differs depending on degree of activity of magnesia. As a result, in a case of using an annealing separator of which activity distribution of magnesia has been adjusted in accordance with the conditions specified in JP '054 and which contains alkali earth metal ions, temperature at which the inhibitor substance is decomposed rises and formation of the forsterite film unevenly proceeds predominantly at sites where low-activity magnesia component exists, whereby inhibitor components derived from the inhibitor substance are concentrated at a portion where the forsterite film has not been formed yet. Consequently, specific elements may exist in a concentrated manner at an interface between the forsterite film and base steel sheet and/or in the forsterite film in some applications, as shown in secondary electron images in the vicinity of an interface between base steel sheet and forsterite film of FIG. 1, which images are observed at a cross section in a direction orthogonal to the rolling direction of a steel sheet product having insulating coating on forsterite film.

Further, JP '054 discloses that low-activity component, intermediate-activity component, and high-activity component of magnesia contribute to concentrations at a steel sheet surface of alkali earth metal, Mg, and Ti, respectively. Judging from these facts, there is a possibility that use of magnesia having such activity distribution μ(A) as disclosed in JP '054 facilitates concentration of inhibitor components derived from inhibitor substance at a steel sheet surface when magnesia having the activity distribution μ(A) is used, although relationship between such specific magnesia as described above and the inhibitor components has not been clearly revealed.

In a case where a steel sheet including inhibitor components in such a concentrated manner as described above is subjected to magnetic domain refinement utilizing thermal strains caused by a plasma flame or laser, the forsterite film may be damaged and/or adhesion properties of the film may deteriorate because coefficients of thermal expansion are different between a portion where specific elements have been coagulated and concentrated and portions surrounding the portion of the forsterite film. Further, tension imparted to the steel sheet by an insulating coating formed on the forsterite film is made non-uniform, which may make it impossible to obtain a sufficient iron-loss reducing effect.

In view of the facts described above, it could be helpful to provide a grain oriented electrical steel sheet successfully exhibiting low iron loss by carrying out magnetic domain refinement free of the iron-loss deteriorating factors described above.

### SUMMARY

We first investigated a method of quantitatively analyzing a specific element-concentrated portion formed in a steel sheet when magnesia having the specific activity distribution disclosed in JP '054 is used. As a result, we succeeded in quantitatively analyzing a specific element-concentrated portion by scanning a surface of the steel sheet by using an EPMA (Electron Probe Micro Analyzer) at acceleration voltage: 10 kV to 20 kV. Specifically, FIG. 2 shows a two-dimensional mapping image of element Se, obtained by observing an observation field (100 μm×100 μm) at measurement pitch: 0.5 μm by using an EPMA. Each dot-like portion observed in FIG. 2 represents a Se-concentrated portion. A specific element-concentrated portion may spread in a solid-solute state throughout forsterite film, depending on types of the element. When a cross-sectional observation was carried out, by regarding a portion exhibiting intensity at least 56 higher than the average of background intensity (“σ” represents the standard deviation of the background intensity) as a specific element-concentrated portion, presence of specific element-concentrated portions as shown in FIG. 1 was confirmed. Accordingly, a specific element-concentrated portion is defined as a portion exhibiting intensity at least 5σ higher than the average of background intensity (“σ” represents the standard deviation of the background intensity) in analysis of a steel sheet surface and presence ratio of the specific element-concentrated portion in the steel sheet surface is evaluated by an area-occupying ratio per 10000 μm² of an observation field in the present investigation.

Next, we determined a threshold value of presence ratio of specific element-concentrated portion(s), provided that the presence ratio exceeding which threshold value lessens an iron-loss reducing effect by magnetic domain refinement in Experiment 1 in connection with magnetic domain refinement involving: preparing a grain oriented electrical steel sheet having 0.23 mm thickness and Se/S-concentrated portions; and linearly irradiating the grain oriented electrical steel sheet with plasma flame (nozzle diameter: 0.15 mm, gas used for generation of plasma: Ar, voltage: 30V, electric current: 7 A, and scanning rate of nozzle: 200 mm/second) in a direction orthogonal to the rolling direction of the steel sheet with irradiation interval: 5 mm to impart the steel sheet with thermal strain. The results are plotted as a relationship between iron loss and the aforementioned area-occupying ratio of Se/S-concentrated portions in FIG. 3. We discovered that iron loss significantly increases when the area-occupying ratio of Se/S-concentrated portions is 2% or higher, as shown in FIG. 3. Further, we investigated Al-concentrated portions, similarly to the experiment described above and found that iron loss significantly increases when the area-occupying ratio of Al-concentrated portions is 5% or higher.

Further, we studied influences on increase in iron loss and found that irradiation with a plasma flame, which locally imparts a steel sheet with strains to cause magnetic domain refinement, may significantly damage a forsterite film in a case where the forsterite film has a specific structure, i.e., the forsterite film includes specific element-concentrated portions by area-occupying ration thereof equal to or higher than 2%. We therefore investigated a method of imparting the base steel with sufficient thermal strain, while avoiding heating the forsterite film, in connection with the aforementioned materials and discovered that magnetic domain refinement by electron beam irradiation, in particular electron beam irradiation with narrowed irradiation beam diameter and higher scanning rate and acceleration voltage, is very suitable.

We thus provide:
(1) A grain oriented electrical steel sheet, comprising: forsterite film on a surface of base steel sheet and a selenium-concentrated portion in at least one of the forsterite film and an interface between the forsterite film and the base steel sheet by a presence ratio expressed as area-occupying ratio of the Se-concentrated portion, of at least 2%, per 10000 μm² of the surface of the base steel sheet, which has been subjected to magnetic domain refinement treatment by electron beam irradiation.
(2) A grain oriented electrical steel sheet, comprising: forsterite film on a surface of base steel sheet and a sulfur-concentrated portion in at least one of the forsterite film and an interface between the forsterite film and the base steel sheet by a presence ratio expressed as area-occupying ratio of the S-concentrated portion, of at least 2%, per 10000 μm² of the surface of the base steel sheet, which has been subjected to magnetic domain refinement treatment by electron beam irradiation.
(3) A grain oriented electrical steel sheet, comprising: forsterite film on a surface of base steel sheet and an aluminum-concentrated portion in at least one of the forsterite film and an interface between the forsterite film and the base steel sheet by a presence ratio expressed as area-occupying ratio of the Al-concentrated portion, of at least 5%, per 10000 μm² of the surface of the base steel sheet, which has been subjected to magnetic domain refinement treatment by electron beam irradiation.
(4) A method of manufacturing a grain oriented electrical steel sheet, comprising the steps of: preparing a prefinished grain oriented electrical steel sheet having forsterite film on a surface of base steel sheet and a selenium-concentrated portion in at least one of the forsterite film and an interface between the forsterite film and the base steel sheet by a presence ratio expressed as area-occupying ratio of the Se-concentrated portion, of at least 2%, per 10000 μm² of the surface of the base steel sheet; and irradiating the prefinished grain oriented electrical steel sheet with electron beam to subject the steel sheet to magnetic domain refinement.
(5) A method of manufacturing a grain oriented electrical steel sheet, comprising the steps of: preparing a prefinished grain oriented electrical steel sheet having forsterite film on a surface of base steel sheet and a selenium-concentrated portion in at least one of the forsterite film and an interface between the forsterite film and the base steel sheet by a presence ratio expressed as area-occupying ratio of the Se-concentrated portion, of at least 2%, per 10000 μm² of the surface of the base steel sheet; and irradiating the prefinished grain oriented electrical steel sheet with electron beam under conditions including: 0.05 mm≦electron beam diameter≦0.5 mm; scanning rate≧1.0 m/second; and acceleration voltage≧30 kV, to subject the steel sheet to magnetic domain refinement.

In summary, we provide a grain oriented electrical steel sheet, comprising: forsterite film on a surface of base steel sheet and at least one of a selenium-concentrated portion, a sulfur-concentrated portion, and an aluminum-concentrated portion in at least one of the forsterite film and an interface between the forsterite film and the base steel sheet by presence ratio(s) expressed as area-occupying ratio(s) of the Se-concentrated portion, the S-concentrated portion and the Al-concentrated portion, of at least 2%, at least 2% and at least 5%, respectively, per 10000 μm² of the surface of the base steel sheet, which has been subjected to magnetic domain refinement treatment by electron beam irradiation.

Further, we provide a method of manufacturing a grain oriented electrical steel sheet, comprising the steps of: preparing a prefinished grain oriented electrical steel sheet having forsterite film on a surface of base steel sheet and at least one of a selenium-concentrated portion, a sulfur-concentrated portion, and an aluminum-concentrated portion in at least one of the forsterite film and an interface between the forsterite film and the base steel sheet by presence ratio(s) expressed as area-occupying ratio(s) of the Se-concentrated portion, the 5-concentrated portion and the Al-concentrated portion, of at least 2%, at least 2% and at least 5%, respectively, per 10000 μm² of the surface of the base steel sheet; and irradiating the prefinished grain oriented electrical steel sheet with electron beam to subject the steel sheet to magnetic domain refinement.

It is preferable that the prefinished grain oriented electrical steel sheet is irradiated with an electron beam under conditions including: 0.05 mm≦electron beam diameter≦0.5 mm; scanning rate of electron beam≧1.0 m/second; and acceleration voltage≧30 kV.

By subjecting a grain oriented electrical steel sheet having a specific element-concentrated portion in at least one of forsterite film on a surface of base steel sheet and an interface between the forsterite film and the base steel sheet to magnetic domain refinement through irradiation of an electron beam, it is possible to prevent a magnetic domain refinement effect from being reduced by damage to the forsterite film, whereby the magnetic domain refinement effect is maximally caused to achieve very low iron loss.

### BRIEF DESCRIPTION OF THE DRAWINGS

FIG. 1 shows secondary electron images observed at a cross section in a direction orthogonal to the rolling direction of a steel sheet having a Se-concentrated portion in forsterite film.

FIG. 2 is a two-dimensional mapping image showing Se-concentrated portions analyzed by an EPMA.

FIG. 3 is a graph showing relationships between iron loss after plasma flame irradiation treatment and respective area-occupying ratios of Se-concentrated portions and S-concentrated portions.

FIG. 4 is a graph showing relationships between iron loss after electron beam irradiation treatment and respective area-occupying ratios of Se-concentrated portions and S-concentrated portions.

FIG. 5 is a graph showing relationship between iron loss and area-occupying ratio of Al-concentrated portions.

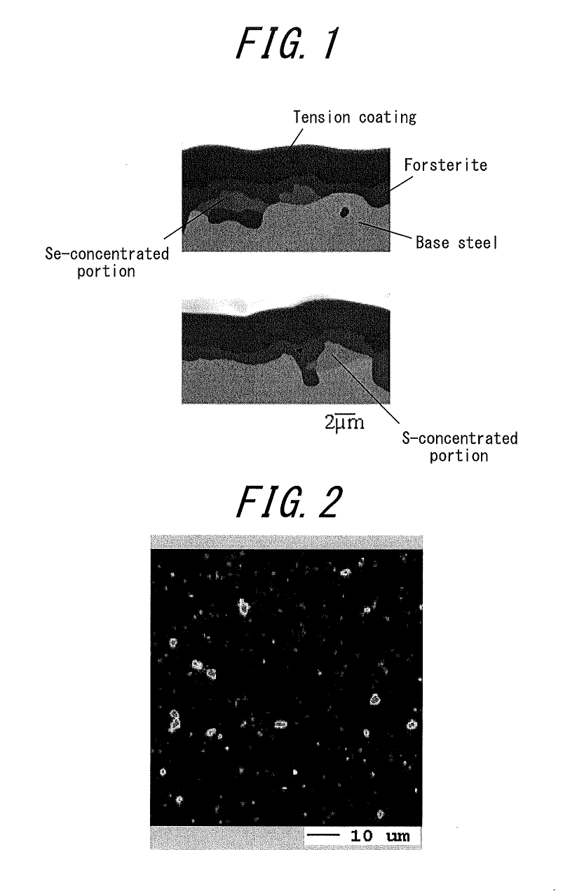

### DETAILED DESCRIPTION

It is critically important that a grain oriented electrical steel sheet having a specific element-concentrated portion in at least one of a forsterite film and an interface between the forsterite film and base steel sheet is subjected to magnetic domain refinement through irradiation of electron beam.

Specifically, the outermost coatings (films), i.e., insulating coating and forsterite film, of a steel sheet are most susceptible to heat when the steel sheet is irradiated with a laser because the laser increases the temperature of a portion irradiated therewith. Similarly, the outermost coatings, i.e., insulating coating and forsterite film, of a steel sheet are most susceptible to heat when the steel sheet is irradiated with a plasma flame because the steel sheet is then directly heated by a flame at temperature equal to or higher than 10000° C. generated by plasma. These methods, i.e., laser and plasma flame, essentially involve in magnetic domain refinement of a steel sheet imparting a steel sheet with thermal strain by transferring heat from a surface toward the inner portion of the steel sheet. Accordingly, the outermost coatings of a steel sheet must be significantly heated to reliably introduce thermal strain necessitated for causing a sufficient iron loss-reducing effect to the inner portion of the steel sheet, which heating gravely affects the outermost coatings.

In contrast, irradiation with an electron beam generates heat through injection of electrons into the inner portion of a steel sheet. Electrons injected into a steel sheet, although they thermally affect the outermost coatings to some extent, can rather directly cause a thermal impact on the base steel sheet because electrons readily pass through the coatings and the surface of the base steel sheet. As a result, irradiation with an electron beam significantly differs from irradiation with a laser or plasma flame in that the former is capable of causing a thermal impact directly on the base steel sheet with suppressing a thermal impact on the outermost coatings.

It is therefore possible to cause a significant thermal impact on a steel sheet, with suppressing a thermal impact on forsterite film thereof, by utilizing the unique characteristics of an electron beam described above. Specifically, in a case where the outermost coatings of a steel sheet are susceptible to heat where a steel sheet has in at least one of forsterite film and an interface between the forsterite film and base steel sheet a specific element-concentrated portion having thermal expansion ratio different from that of forsterite film, a thermal impact on the forsterite film can be well suppressed by our method.

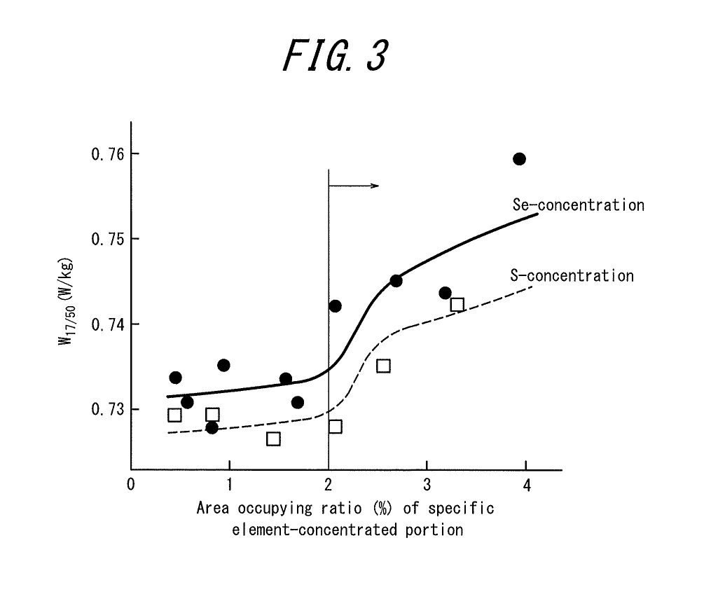

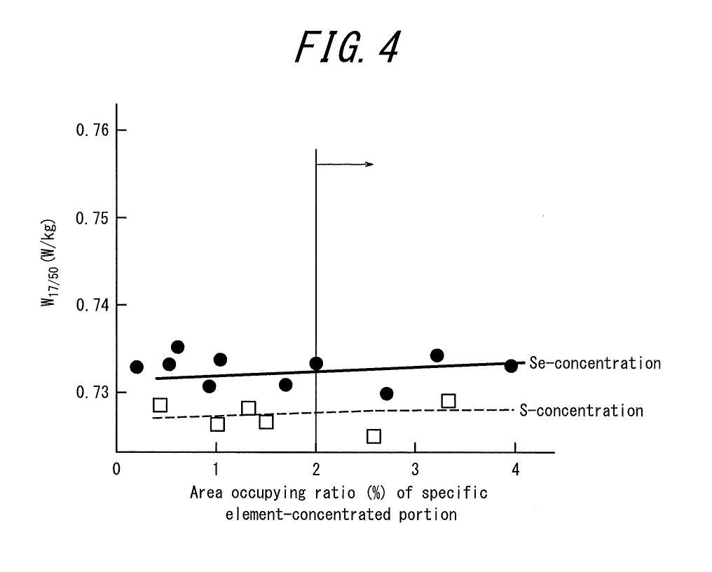

We analyzed iron loss after magnetic domain refinement in an experiment including: preparing a grain oriented electrical steel sheet having 0.23 mm thickness and a Se/S-concentrated portion; and linearly irradiating the steel sheet with electron beam (beam diameter: 0.2 mm, scanning rate: around 3 m/second, acceleration voltage: 30 kV) in a direction orthogonal to the rolling direction of the steel sheet with irradiation interval of 5 mm to impart the steel sheet with thermal strain to cause magnetic domain refinement thereto. The result of the experiment is shown in FIG. 4 as relationships between iron loss and respective area-occupying ratios of Se-concentrated portions and S-concentrated portions. It is understood from FIG. 4 that satisfactorily low iron loss values were obtained even when the area-occupying ratios of Se-concentrated portions and S-concentrated portions exceeded 2% per 10000 μm² of the surface of the base steel sheet, respectively. In other words, it is understood that satisfactorily low iron loss can be maintained even when area-occupying ratio of specific element-concentrated portion(s) exceeds 2% per 10000 μm² of the surface of the base steel sheet, by replacing plasma flame irradiation with electron beam irradiation in magnetic domain refinement when an experiment is carried out under treatment conditions similar to those of the experiment of which results are shown in FIG. 3.

The area-occupying ratio of Se/S-concentrated portions per 10000 μm² of surface of a base steel sheet is preferably suppressed to 50% or less because forsterite film imparts the steel sheet with tension unevenly when the ratio exceeds 50%. Content of Se/S in steel slab need be 0.03 mass % or less when Se or S is used as inhibitor, for example, to curb the area-occupying ratio of Se/S-concentrated portions to 50% or less.

Further, we analyzed various types of grain oriented electrical steel sheets by an EPMA to detect specific element-concentrated portions thereof and identified Al as an element which forms a specific element-concentrated portion. Selenium and sulfur tend to exist in configurations where these elements very complicatedly interact with the forsterite film, thereby significantly affecting the surrounding forsterite film when Se/S-concentrated portions expand due to heat. On the other hand, aluminum tends to exist at an interface between the base steel and forsterite film in a manner that causes a relatively little impact on forsterite film, thereby affecting forsterite film much less than Se and S.

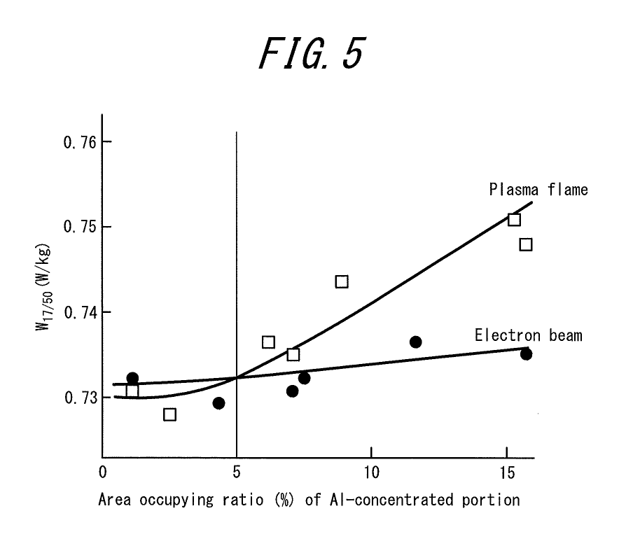

We carried out another experiment to analyze iron loss after magnetic domain refinement in a grain oriented electrical steel sheet having 0.23 mm thickness and an Al-concentrated portion, in the same manner as in the experiment in connection with Se-concentrated portions and S-concentrated portions. The results of the experiment are shown in FIG. 5. We confirmed that iron loss properties of the steel sheet do not deteriorate when the area-occupying rate of Al-concentrated area is around 2%, but deteriorate when the area-occupying rate is equal to or higher than 5% in a case where magnetic domain refinement is achieved by imparting the steel sheet with thermal strain with a plasma flame, as shown in FIG. 5. We also confirmed that deterioration of iron loss properties can be suppressed even when area-occupying rate of Al-concentrated area is equal to or higher than 5% by carrying out magnetic domain refinement with an electron beam (see FIG. 5).

An area-occupying ratio of Al-concentrated portions per 10000 μm² of surface of a base steel sheet is preferably suppressed to 50% or less because forsterite film imparts the steel sheet with tension unevenly when the ratio exceeds 50%. Content of Al in steel need be 0.065 mass % or less when Al is used as inhibitor to curb the area-occupying ratio of Al-concentrated portions to 50% or less.

Regarding the electron beam used in magnetic domain refinement, it is assumed that a larger irradiation area and/or longer irradiation time causes a greater thermal impact on the forsterite film. Further, low acceleration voltage allows an electron beam injected into a steel sheet to stay in the vicinity of a surface layer of the steel sheet, thereby possibly intensifying an impact on forsterite film. In view of this, we investigated the best conditions to allow an electron beam to pass through the forsterite film and imparting the base steel sheet itself with thermal strain.

Specifically, we carried out an experiment including irradiating a grain oriented electrical steel sheet having thickness: 0.23 mm and area-occupying ratio of Se-concentrated portions: 3±0.5% with electron beam to impart the steel sheet with thermal strain to carry out magnetic domain refinement in the steel sheet and then measuring iron loss of the steel sheet. Electron beam diameter was set to be 0.1 mm, 0.3 mm, 0.5 mm, 0.7 mm, 0.9 mm and 1.0 mm, respectively, to change irradiation area. “Diameter” literally represents a diameter, i.e., distance across a beam cross section unless mentioned otherwise. Scanning rate and acceleration voltage of electron beam were fixed at 2 m/second and 50 kV, respectively, in this connection.

On the other hand, when the irradiation time was changed, the scanning rate was set to 0.1 m/second, 0.5 m/second, 1.0 m/second, 2.0 m/second and 3.0 m/second, respectively, while electron beam diameter and acceleration voltage were fixed at 0.3 mm and 50 kV as the standard values, respectively. When acceleration voltage was changed, the acceleration voltage was set to 10 kV, 20 kV, 30 kV, 50 kV and 100 kV, respectively, while the electron beam diameter and scanning rate were fixed at 0.3 mm and 2 m/second as the standard values, respectively. As a result, the electron beam is preferably 0.5 mm or less, scanning rate is preferably at least 1.0 m/second, and acceleration voltage is preferably at least 30 kV in terms of improving iron loss properties.

It is preferable to employ an irradiation direction, an irradiation interval, and the like generally suitable for thermal strain-imparting type magnetic domain refinement when a steel sheet is irradiated with an electron beam. Specifically, irradiation with an electron beam is effectively carried out by dot-like or linear irradiation using electric current of 0.005 mA to 10 mA in a direction intersecting the rolling direction (preferably a direction inclined with respect to the rolling direction by 60° to 90°) with irradiation interval of 3 mm to 15 mm in the rolling direction.

A grain oriented electrical steel sheet may be any of conventionally known grain oriented electrical steel sheets. Examples of the conventionally known grain oriented electrical steel sheets include an electrical steel material containing Si by 2.0 mass % to 8.0 mass %.

Si: 2.0 mass % to 8.0 mass %

Silicon is an element which effectively increases electrical resistance of steel to improve iron loss properties thereof. Silicon content in steel equal to or higher than 2.0 mass % ensures a particularly good effect of reducing iron loss. On the other hand, Si content in steel equal to or lower than 8.0 mass % ensures particularly good formability and magnetic flux density of steel. Accordingly, Si content in steel is preferably 2.0 mass % to 8.0 mass %.

The higher degree of accumulation of crystal grains in <100> direction causes the better effect of reducing iron loss through magnetic domain refinement. Magnetic flux density B₈ as an index of accumulation of crystal orientations is therefore preferably at least 1.90 T.

In manufacturing the grain oriented electrical steel sheet, the chemical composition of the steel material for the steel sheet may contain the following components as starting components.

C: 0.08 mass % or less

Carbon is added to improve the microstructure of a hot rolled steel sheet. Carbon content in steel is preferably 0.08 mass % or less because carbon content exceeding 0.08 mass % increases the burden of reducing carbon content during the manufacturing process to 50 mass ppm or less at which magnetic aging is reliably prevented. The lower limit of carbon content in steel need not be particularly set because secondary recrystallization is possible in a material not containing carbon.

Mn: 0.005 mass % to 1.0 mass %

Manganese is an element which advantageously achieves good hot-formability of steel. Manganese content in steel less than 0.005 mass % cannot cause the good effect of Mn addition sufficiently. Manganese content in steel equal to or lower than 1.0 mass % ensures particularly good magnetic flux density of a product steel sheet. Accordingly, Mn content in steel is preferably 0.005 mass % to 1.0 mass %.

When an inhibitor is used to facilitate secondary recrystallization, the chemical composition of the steel material for the grain oriented electrical steel sheet may contain, for example, appropriate amounts of Al and N in a case where an AlN-based inhibitor is utilized or appropriate amounts of Mn and Se and/or S in a case where MnS and/or MnSe-based inhibitor is utilized. Both AlN-based inhibitor and MnS.MnSe-based inhibitor may be used in combination, of course. When inhibitors are used as described above, contents of Al, N, S and Se are preferably Al: 0.01 mass % to 0.065 mass %, N: 0.005 mass % to 0.012 mass %, S: 0.005 mass % to 0.03 mass %, and Se: 0.005 mass % to 0.03 mass %, respectively.

Further, the steel material for the grain oriented electrical steel sheet may contain, for example, the following elements as magnetic properties improving components in addition to the basic components described above:
At least one element selected from Ni: 0.03 mass % to 1.50 mass %, Sn: 0.01 mass % to 1.50 mass %, Sb: 0.005 mass % to 1.50 mass %, Cu: 0.03 mass % to 3.0 mass %, P: 0.03 mass % to 0.50 mass %, Mo: 0.005 mass % to 0.10 mass %, Nb: 0.0005 mass % to 0.0100 mass %, and Cr: 0.03 mass % to 1.50 mass %.

Nickel is a useful element in terms of further improving the microstructure of a hot rolled steel sheet and thus magnetic properties of a resulting steel sheet. Nickel content in steel less than 0.03 mass % cannot cause this magnetic properties-improving effect by Ni sufficiently. Nickel content in steel equal to or lower than 1.5 mass % ensures stability in secondary recrystallization to improve magnetic properties of a resulting steel sheet. Accordingly, Ni content in steel is preferably 0.03 mass % to 1.5 mass %.

Sn, Sb, Cu, P, Mo, Nb and Cr are useful elements, respectively, in terms of further improving magnetic properties of the grain oriented electrical steel sheet. Contents of these elements lower than the respective lower limits described above result in an insufficient magnetic properties-improving effect. Contents of these elements equal to or lower than the respective upper limits described above ensure the optimum growth of secondary recrystallized grains. Accordingly, it is preferable that the steel material for the grain oriented electrical steel sheet contains at least one of Sn, Sb, Cu, P, Mo, Nb and Cr within the respective ranges thereof specified above.

The balance other than the aforementioned components of the steel material for the grain oriented electrical steel sheet is preferably Fe and incidental impurities incidentally mixed thereinto during the manufacturing process.

A steel slab having the aforementioned chemical composition is subjected to the conventional processes for manufacturing a grain oriented electrical steel sheet including annealing for secondary recrystallization and formation of a tension insulating coating thereon, to be finished as a grain oriented electrical steel sheet. Specifically, a grain oriented electrical steel sheet is manufactured by: subjecting the steel slab to heating and hot rolling to obtain a hot rolled steel sheet; subjecting the hot rolled steel sheet to either a single cold rolling operation or at least two cold rolling operations with intermediate annealing therebetween to obtain a cold rolled steel sheet having the final sheet thickness; and subjecting the cold rolled steel sheet to decarburization, annealing for primary recrystallization, coating of an annealing separator mainly composed of magnesia, and the final annealing including secondary recystallization process and purification process in this order.

“Annealing separator mainly composed of magnesia” means that the annealing separator may contain known annealing separator components and/or physical/chemical property-improving components other than magnesia unless presence thereof inhibits formation of forsterite film.

Regarding magnesia as an annealing separator, magnesia having an activity distribution with the expected value μ(A) of 3.4 to 3.7 and the standard deviation σ(A) of 2.0 to 2.6 may be preferentially used.

The expected value μ(A) and the standard deviation σ(A) can be calculated as follows. First, random variable (A) is defined as below:

A=Lnt(“Lnt” represents natural logarithm of reaction time t(s))

Provided that: P (A)=dR/d(Lnt)=dR/dA (“R” represents reaction rate of magnesia),

μ(A)=∫A·P(A)dA

σ(A)=[∫{(A−μ)²·P(A)}dA]^{1/2}.

The method disclosed in paragraphs [0017] to [0023] of JP '054 described above can be employed as a specific method to determine activity distribution of magnesia. Further, preferable conditions and adjusting methods regarding activity distribution and annealing separator are preferably selected based on the descriptions in paragraphs [0041] to [0045] of JP '054. Specifically, the annealing separator preferably contains Ti compound by 0.5-6 parts by mass (when converted into Ti content) and at least one of Ca, Sr, Ba and Mg compounds by 0.2-3.0 parts by mass (when converted into content of the relevant metal) with respect to 100 parts by mass of magnesia. The annealing separator may further contain additives to improve various physical/chemical properties thereof.

Specific elements such as Se, S and Al may be concentrated in the forsterite film when magnesia as described above is used as an annealing separator. This phenomenon occurs presumably because there arises a state where formation of the forsterite film has been only partially completed at the temperature at which the inhibitor substance is decomposed and specific elements derived therefrom migrate to a steel sheet surface to be concentrated there, whereby concentration of the specific elements preferentially proceeds at portions where the forsterite film has not been formed yet.

This concentration problem of Se, S and Al does not generally occur in cases where the conventional annealing separators other than that described in JP '054 are employed. Therefore, we are particularly effective in terms of solving the problem revealed in the technique proposed in JP '054 utilizing as an annealing separator a unique magnesia having an activity distribution with a specifically controlled expected value, i.e., addressing the problem that a magnetic domain refinement effect deteriorates due to concentration of Se, S and Al. Accordingly, it is preferable to apply, regarding an annealing separator, the technique disclosed in JP '054.

Our methods are effectively applicable to not only the technique of JP '054, but also every case where improvement of a grain oriented electrical steel sheet and/or a method for the grain oriented electrical steel sheet causes Se, S and/or Al to be concentrated in a forsterite film and/or an interface between the coating and base steel sheet. For example, regardless of the effect of an annealing separator, there is a case where forsterite film formation does not proceed uniformly, but occurs concurrently with concentration of inhibitor-derived components at a steel sheet surface due to controllable change in atmosphere during final annealing, whereby the resulting forsterite film includes specific element-concentrated portions.

A steel sheet thus subjected to final annealing according to our method described above is then provided, by coating, with a tension insulating coating composed of, e.g., colloidal silica and a phosphate salt (magnesium phosphate, aluminum phosphate or the like) and baked.

In the irradiation with an electron beam, the steel sheet is irradiated, for example, in a direction inclined with respect to the rolling direction of the steel sheet by 60° to 90° (preferably 90° or in a widthwise direction) with an electron beam of which beam diameter at an irradiation position has been converged to 0.05 mm to 1 mm so that thermal strain is introduced in a linear or dot-like manner to the steel sheet.

The upper and lower limits of electron beam diameter are 0.05 mm and 1.0 mm, respectively, and the beam diameter is preferably 0.5 mm or less to ensure good physical properties. The beam diameter is to be at least 0.05 mm because too small beam diameter lessens the effect of dividing magnetic domains for magnetic domain refinement. On the other hand, the beam diameter is equal to or smaller than 1.0 mm because too large a beam diameter increases the area where strain is introduced and deteriorates hysteresis loss properties in particular. An electron beam diameter equal to or smaller than 0.5 mm is preferable because hysteresis loss properties are prevented from deteriorating and an iron loss-improving effect can be maximally obtained.

Regarding scanning rate, an adverse effect on the forsterite film can be avoided by setting scanning rate at least 1.0 m/second. The upper limit of the scanning rate does not particularly need to be specified. The scanning rate is preferably 1000 m/second or less in view of required facilities because an excessively high scanning rate necessitates high energy (electric current, voltage) to maintain sufficiently high output per unit length of a steel sheet.

Regarding the acceleration voltage, an acceleration voltage of 30 kV or higher allows an electron beam to pass through the forsterite film to directly impart a steel sheet with thermal strain. The upper limit of acceleration voltage does not particularly need to be specified. The acceleration voltage is preferably equal to or lower than 300 kV because irradiation with too high an acceleration voltage causes strain to widely spread in a steel sheet in the depth direction thereof and makes it difficult to control the strain depth within a preferred range.

Output of the electron beam is 10 W to 2000 W and irradiation conditions are preferably adjusted such that irradiation is carried out linearly with output of the electron beam per unit length at around 1 J/m to 50 J/m and the irradiation interval of around 1 mm to 20 mm.

The depth of strain imparted to a steel sheet through irradiation with an electron beam is preferably 5 μm to 30 μm measured from a steel sheet surface.

Needless to say, the foregoing descriptions do not prevent electron beam irradiation conditions other than described above from being applied.

### Example 1

A grain oriented electrical steel sheet having the final sheet thickness of 0.23 mm was prepared from a steel slab containing Si by 3 mass % by manufacturing processes using at least one of MnSe, MnS and AIN as inhibitor elements. The manufacturing processes of the grain oriented electrical steel sheet included: obtaining a cold rolled steel sheet having the final sheet thickness by rolling; and subjecting the cold rolled steel sheet to decarburization, annealing for primary recrystallization, coating of annealing separator mainly composed of MgO having activity distribution with the expected value μ(A) in the range of 3.4 to 3.7 and the standard deviation σ(A) in the range of 2.0 to 2.6, and final annealing including secondary recrystallization process and purification process at the maximum temperature of 1200° C. with 10-hour soaking time in this order. The electrical steel sheet having forsterite film thus obtained was provided, by coating, with insulating coating made of 60% colloidal silica and aluminum phosphate such that coating weight was 5 g/mm² per one surface and baked at 800° C.

Test specimens were cut out of the center portion in the coil widthwise direction of the grain oriented electrical steel sheet thus prepared. B₈ value of each of these test specimens was measured. The test specimens exhibiting B₈ value of 1.92 T±0.001 T were selected. Area-occupying ratios of respective specific element-concentrated portions were determined by using an EPMA for each of the test specimens thus selected.

Next, each of the test specimens thus selected was subjected to magnetic domain refinement in a direction orthogonal to the rolling direction by using two different magnetic domain refinement techniques, i.e., plasma flame and electron beam, and then iron loss after magnetic domain refinement of the test specimen was measured. Irradiation with an electron beam was carried out at two levels: 0.3 mm and 1 mm for irradiation beam diameter, two levels: 2 m/second and 0.5 m/second for scanning rate, and two levels: 20 kV and 100 kV for acceleration voltage.

The measurement results, as well as the corresponding parameters, of Example 1 described above are shown in Table 1. It is understood from Table 1 that satisfactory iron loss properties were successfully obtained without deterioration thereof under the electron beam irradiation conditions (i.e., Example-type A and Example-type B). It is also understood from Table 1 that better iron loss properties were successfully obtained by electron beam irradiation within the condition ranges of Example-type A than in Example-type B.

TABLE 1

| | | Area- | Area- | Area- | | | | | | |
|---|---|---|---|---|---|---|---|---|---|---|
| Steel | | occupying | occupying | occupying | Magnetic | Conditions of electron | | | Iron loss | |
| sheet | | ratio of Se- | ratio of S- | ratio of Al- | domain | beam irradiation | | | value | |
| sample | | concentrated | concentrated | concentrated | refinement | Beam | Scanning | Acceleration | W_{17/50} | |
| No. | Inhibitor | portion | portion | portion | means | diameter | rate | voltage | (W/kg) | Note |
| 1 | MnSe | 8.0% | <1% | <1% | Plasma flame | — | — | — | 0.749 | Comp. |
| | | | | | | | | | | Example |
| 2 | | 6.5% | <1% | <1% | Electron beam | 0.3 mm | 2 m/second | 100 kV | 0.728 | Example- |
| | | | | | | | | | | type A |
| 3 | | 1.8% | <1% | <1% | Electron beam | 0.3 mm | 0.5 m/second | 100 kV | 0.730 | Reference |
| | | | | | | | | | | Example |
| 4 | | 6.5% | <1% | <1% | Electron beam | 1.0 mm | 0.5 m/second | 20 kV | 0.734 | Example- |
| | | | | | | | | | | type B |
| 5 | MnS | <1% | 1.8% | <1% | Electron beam | 0.3 mm | 2 m/second | 100 kV | 0.725 | Reference |
| | | | | | | | | | | Example |
| 6 | | <1% | 4.5% | <1% | Electron beam | 0.3 mm | 2 m/second | 100 kV | 0.725 | Example- |
| | | | | | | | | | | type A |
| 7 | | <1% | 1.8% | <1% | Plasma flame | — | — | — | 0.727 | Reference |
| | | | | | | | | | | Example |
| 8 | | <1% | 4.5% | <1% | Plasma flame | — | — | — | 0.748 | Comp. |
| | | | | | | | | | | Example |
| 9 | AlN | <1% | <1% | 3.0% | Electron beam | 0.3 mm | 2 m/second | 20 kV | 0.731 | Reference |
| | | | | | | | | | | Example |
| 10 | | <1% | <1% | 7.0% | Electron beam | 0.3 mm | 2 m/second | 20 kV | 0.735 | Example- |
| | | | | | | | | | | type B |
| 11 | | <1% | <1% | 8.0% | Electron beam | 0.3 mm | 2 m/second | 100 kV | 0.729 | Example- |
| | | | | | | | | | | type A |
| 12 | | <1% | <1% | 7.0% | Plasma flame | — | — | — | 0.742 | Comp. |
| | | | | | | | | | | Example |

### Example 2

A steel slab containing Si by 3 mass % was manufactured by using both MnSe and AN as inhibitor elements. A grain oriented electrical steel sheet having the final sheet thickness of 0.27 mm was prepared from the steel slab. The manufacturing processes of the grain oriented electrical steel sheet included: obtaining a cold rolled steel sheet having the final sheet thickness by rolling; and subjecting the cold rolled steel sheet to decarburization, annealing for primary recrystallization, coating, on a steel sheet surface, of annealing separator composed of MgO having activity distribution as specified in JP '054 as the main component and Sr compound and Ti compound as an auxiliary component, and coiling with interlayer interval of 15 μm in this order to obtain a coiled steel sheet. The coiled steel sheet was subjected to final annealing (the maximum temperature: 1200° C., soaking time: 10 hours). The electrical steel sheet having forsterite film thus obtained was provided, by coating, with insulating coating made of 60% colloidal silica and aluminum phosphate and baked at 800° C.

Test specimens were cut out of the center portion in the coil widthwise direction of the grain oriented electrical steel sheet thus prepared. B₈ value of each of these test specimens was measured. The test specimens exhibiting B₈ value of 1.91 T±0.001 T were selected. The area-occupying ratio of Se-concentrated portions was determined by using an EPMA for each of the test specimens thus selected. Each of the test specimens exhibited an area-occupying ratio of Se-concentrated portions of at least 2%.

Next, one of the test specimens thus obtained was irradiated with plasma flame in a direction orthogonal to the rolling direction for magnetic domain refinement (Comparative Example). Other test specimens were each irradiated with electron beam for magnetic domain refinement. Irradiation interval was unanimously 5 mm. Iron loss after magnetic domain refinement was measured for each of the test specimens. Irradiation conditions of the electron beam, measured physical properties, and relevant parameters are summarized in Table 2. It is understood from Table 2 that satisfactory iron loss properties were successfully obtained by electron beam irradiation (Example-type C and Example-type D). It is also understood from Table 2 that better iron loss properties were successfully obtained by more adequate electron beam irradiation (Example-type D) than otherwise (Example-type C).

TABLE 2

| | | | Iron loss value | |
|---|---|---|---|---|
| Conditions of electron beam irradiation | | | W_{17/50} | |
| Beam diameter | Scanning rate | Acceleration voltage | (W/kg) | Note |
| — | Plasma jet irradiation | — | 0.812 | Comp. Example |
| 0.03 mm | 5 m/s | 50 kV | 0.805 | Example-type C |
| 0.05 mm | 0.5 m/s | 50 kV | 0.795 | Example-type C |
| | 1 m/s | 50 kV | 0.782 | Example-type D |
| | 10 m/s | 50 kV | 0.782 | Example-type D |
| 0.10 mm | 0.5 m/s | 50 kV | 0.791 | Example-type C |
| | 5 m/s | 50 kV | 0.773 | Example-type D |
| | 300 m/s | 300 kV | 0.781 | Example-type D |
| 0.30 mm | 50 m/s | 50 kV | 0.774 | Example-type D |
| | | 20 kV | 0.790 | Example-type C |
| 0.50 mm | 0.5 m/s | 30 kV | 0.797 | Example-type C |
| | 5 m/s | | 0.776 | Example-type D |
| 1.00 mm | 100 m/s | 50 kV | 0.807 | Example-type C |

1. A grain oriented electrical steel sheet comprising:
forsterite film on a surface of base steel sheet; and
an aluminum-concentrated portion in at least one of the forsterite film and an interface between the forsterite film and the base steel sheet by a presence ratio expressed as area-occupying ratio of the Al-concentrated portion, of at least 5%, per 10000 μm² of the surface of the base steel sheet,
which has been subjected to magnetic domain refinement treatment by electron beam irradiation.
